(19) United States
(12) Patent Application Publication
(10) Pub. No.: US 2026/0261578 A1
(43) Pub. Date: Sep. 3, 2026

(54) INTELLIGENT SYSTEM AND METHODS FOR IDENTIFYING NODE SPOOFING IN A DISTRIBUTED LEDGER NETWOK USING FUZZY DECISION TWIN AND FORKING MECHANISM

(71) Applicant: Bank of America Corporation, Charlotte, NC (US)

(72) Inventors: Sanjay Ashok Patil, Gandhinagar Gujrat (IN); Srijeet Majumder, Chennai (IN); Nisha Dahiya, Delhi (IN); Divya Nagarajan, Chennai (IN)

(21) Appl. No.: 19/068,060

(22) Filed: Mar. 3, 2025

(51) Int. Cl. H04L 9/40

(52) U.S. Cl. CPC H04L 63/1466

(57) ABSTRACT

Systems and methods for identifying node spoofing in a distributed ledger network (“DLN”). The system and methods may include a fuzzy decision twin and forking mechanism (“FDTFM”). The FDTFM may identify node spoofing in the DLN. The system and methods may include a fuzzy analytical hierarchical (“FAH”) process, which may capture a consensus from nodes and generate a simulated decision twin environment (“SDTE”). Systems and methods may include a nodal deoxyribonucleic acid (“DNA”) generator, which may control and configure information from the nodes to generate nodal DNA. The nodal DNA may include a unique identifier, nodal configurations, node roles, behavioral patterns, and storage capacity. The system and methods may include a decision process for lower deviation and higher deviation for nodal forking. The system and methods may include an intelligent nodal validator, which may learn from fork node behavior, and may update an ideal nodal genome for improved decision making.

### FIELD OF TECHNOLOGY

Aspects of the disclosure relate to systems and methods for identifying node spoofing in a distributed ledger network (“DLN”). Particularly, aspects of the disclosure relate to systems and methods using a fuzzy decision twin and forking mechanism (“FDTFM”) for identifying node spoofing in a DLN.

### BACKGROUND OF THE DISCLOSURE

Node spoofing is a significant threat to decentralized systems, such as blockchain networks, which rely on the consensus of multiple nodes to maintain their integrity and security. However, these systems are vulnerable to node spoofing where single attackers create multiple fake identities or nodes to gain a disproportionate amount of influence over the network. This can lead to various issues, such as double-spendings, network partitioning and consensus failure.

Sources of node spoofing can include malicious factors creating multiple fake identities or nodes and gaining a disproportionate amount of influence over a network. These nodes can be generated using various techniques, such as identity theft, botnets, lack of identity verification, and low barrier to entry.

The current solutions that we have in the system to address node spoofing in blockchain environment are 1) proof of work is energy-intensive and computationally expensive, making it unsuitable for certain applications; and 2) proof of stake favors entities with large holding, potentially both solutions may not be effective against sophisticated nodal spoofing involving botnets or compromised devices. Identifying the source of such an attack as early as possible may help to reduce fraud in blockchain.

Real-world example impact of sybil attacks include decentralized finance (“DeFi”) platforms: Sybil attacks of DeFi platforms could enable attackers to manipulate voting process or exploit vulnerabilities for financial gain. Real-world example of node spoofing on business has in significant financial losses and reputation damage.

Therefore, a novel approach to node spoofing prevention in a decentralized system is necessary to ensure the security and integrity of these networks.

### SUMMARY OF THE DISCLOSURE

Provided herein are systems and methods for identifying node spoofing in a DLN. Systems and methods may use an FDTFM for identifying node spoofing in a DLN.

Systems and methods may capture a consensus from nodes and generate a simulated decision twin based on a Fuzzy Analytical Hierarchical (“FAH”) process. The simulated consensus may be derived from inputs from an intelligent nodal validator, fuzzy output and nodal models from a nodal database (“DB”) to derive a decision deviation.

Systems and methods may include a nodal deoxyribonucleic acid (“DNA”) generator. The nodal DNA generator may control and configure information from the nodes to generate nodal DNA containing a unique identifier, nodal configurations, node roles, behavioral patterns, and storage capacity for storing blockchain information. The nodal DNA generator may pass feedback information across nodes to publish DNA information as feedback. The nodal DNA generator may also capture transactional information to determine behavior of the nodes.

Systems and methods may include a decision deviation. The decision deviation may be used to generate a decisioning of forking of the nodes from the DLN. A processed decision for lower deviation and higher deviation may generate a unique technique for nodal forking. This process may enable soft forking where a consensus from a possible node is identified as faulty and tolerated in the environment. Similarly, when hard forking is decided the node may be blacklisted and completely forked out of the ledger.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout.

FIG. 1 shows an illustrative flow chart 100 for a system and method in accordance with principles of the disclosure.

FIG. 2A shows an illustrative diagram 200 for a system and method in accordance with principles of the disclosure.

FIG. 2B shows an illustrative diagram 200 for a system and method in accordance with principles of the disclosure.

FIG. 3 shows an illustrative flow chart 300 for a system and method in accordance with principles of the disclosure.

FIG. 4 shows an illustrative flow chart 400 for a system and method in accordance with principles of the disclosure.

FIG. 5 shows a schematic diagram 500 in accordance with principles of the disclosure.

FIG. 6 shows an illustrative diagram 600 for a system and method in accordance with principles of the disclosure.

FIG. 7 shows an illustrative diagram 700 for a system and method in accordance with principles of the disclosure.

FIG. 8 shows an illustrative diagram 800 for a system and method in accordance with principles of the disclosure.

FIG. 9 shows an illustrative block diagram of system 900 in accordance with principles of the disclosure.

FIG. 10 shows an illustrative block diagram of system 1000 in accordance with principles of the disclosure.

### BRIEF DESCRIPTION OF THE DRAWINGS

Systems and methods for identifying node spoofing in a DLN are provided. Systems and methods may use an FDTFM for identifying node spoofing in a DLN.

An exemplary method for identifying node spoofing may be a received signal strength (“RSS”) analysis. An RSS analysis may detect node spoofing by analyzing RSS values received from nodes. RSS readings from a single node may cluster around a mean vector. But during a spoofing attack, RSS readings from a same media access control (“MAC”) address may form multiple distinct clusters, indicating transmissions from different physical locations.

Another exemplary method for identifying node spoofing may be a number of connected neighbors (“NCN”) analysis. An NCN analysis may identify node spoofing by monitoring the number of connections a node maintains. When a spoofing attack occurs, a core node may detect an abnormal increase in the number of connections or distance beyond a predefined threshold. For example, if a normal operating range is 100 meters and the operating range suddenly increases to 300 meters, this may indicate the presence of spoofing nodes.

Systems and methods may include a way of generating nodal DNA from extracted node configurations and transactional behavior. Systems and methods may add to an update nodal behavior by incremental genome updates to understand and publish nodal behavior.

Systems and methods may include decision twin and decision deviation solutions to enable nodal forking. Systems and methods may include an adaptive nodal forking mechanism as a unique mechanism to eliminate spoofed nodes.

Systems and methods may include multi-step soft nodal forking and hard nodal forking methods to identify feedback nodal behavior and eliminate spoofed nodes after decision deviation evaluation based on the decision twin engine. Systems and methods may include an intelligent nodal validator with the ability to learn from the fork node behavior and update an ideal nodal genome for better decision making.

Systems and methods may include usage of a FAH process to evaluate consensus provided by the nodes and derive valid weights based on the set criteria and attributes that are unique in DLNs. Systems and methods may include deployment of a FAH process as a smart contract on each node, enabling decentralized and autonomous evaluation of node behavior.

Systems and methods may include dynamic decision deviation evaluation in a unique DLN. Systems and methods may include integration of simulated decision twin environment to evaluate and reconcile the behavior of blacklisted node, ensuring a more efficient and effective reconciliation process.

Systems and methods may include implementation of temporary blockchain forking or soft forking enabling a more secure and efficient reconciliation mechanism. Systems and methods may include combining methods for identifying node spoofing using fuzzy algorithm and decision twin solution, providing a robust and effective approach to detect and mitigate node spoofing in distributed system.

Systems may include an FDTFM. The FDTFM may identify node spoofing in the DLN. Systems may include a FAH process. The FAH may capture a consensus from nodes. The FAH may generate a simulated decision twin environment (“SDTE”). The FAH may generate the SDTE based on a simulated consensus. The simulated consensus may be derived from, e.g., inputs from an intelligent nodal validator, fuzzy output, and nodal models from a nodal database (“DB”).

An exemplary intelligent nodal validator may include an intelligent nodal validator in blockchain networks using advanced techniques to detect and prevent spoofing attacks. One exemplar is a validator node that employs a Graph Attention Network (“GAT”) to model relationships between different sub-bands and temporal segments of data. The GAT approach allows the validator to learn which sub-bands or segments are most informative with regard to their neighbors, assign weights to emphasize the most discriminative data points, and model non-Euclidean data manifolds spanning different sub-bands and temporal segments.

An exemplary fuzzy output may include a fuzzy logic system for spoofing detection. The fuzzy logic system may produce outputs based on input variables and predefined rules. The fuzzy logic system may detect nodes with variable signal levels outside a defined interval, classify nodes as suspicious or mobile based on energy level frequencies, and estimate node location using improved fuzzy techniques. For example, the fuzzy logic system may output a “spoofing likelihood” score between 0 and 1, where spoofing likelihood values closer to 1 indicate a higher probability of a spoofing attack.

Exemplary nodal models may include spoofing detection considering various characteristics of network nodes to identify anomalies. An exemplary nodal model is the RSS model. The RSS model may analyze RSS values from nodes to detect node spoofing. Key features of the RSS model may include establishing a threshold value for normal operation (e.g., 100 meter radio range), detecting anomalies when the distance exceeds the threshold value, and using unicasting to send data to legitimate and/or potential spoofing nodes.

Another exemplary nodal model may be the NCN model. The NCN model may monitor the number of connections a node maintains. The NCN model may detect spoofing when multiple requests are received by a core node in the same period, flood a data transmission and reception (“DTAR”) request to neighboring nodes, and identify spoofing attacks when data transmission exceeds a threshold value.

The simulated consensus may derive a decision deviation. The decision deviation may generate a decisioning of forking of the nodes from the DLN. Systems may include a nodal deoxyribonucleic acid (“DNA”) generator. The nodal DNA generator may control and configure information from the nodes. The nodal DNA generator may generate nodal DNA. The nodal DNA may include, e.g., unique identifier(s), nodal configuration(s), node role(s), behavioral pattern(s), and storage capacity. The storage capacity may store, e.g., blockchain information.

Systems may include a decision process. The decision process may be for lower deviation. The decision process may be for higher deviation. The decision process may generate nodal forking.

Systems may include an intelligent nodal validator. The intelligent nodal validator may learn from fork node behavior. The intelligent nodal validator may update an ideal nodal genome for improved decision making.

Systems may include an FAH process operable to evaluate a consensus provided by the nodes. Systems may include an FAH process operable to derive valid weights based on set criteria and attributes unique to the DLN.

Systems may include an FAH process operable to execute smart contracts on the nodes. The smart contracts may enable a decentralized and autonomous evaluation of nodal behavior.

Systems may include a DNA generator operable to generate nodal DNA from extracted node configurations and transactional behavior. Systems may include a DNA generator operable to add an update to the nodal behavior by incremental genome updates. Systems may include a DNA generator operable to analyze and publish the nodal behavior.

The nodal DNA generator may be operable to pass feedback information across the nodes to publish DNA information as feedback. The nodal DNA generator may be operable to capture transactional information to determine behavior of the nodes.

The decision process may be operable to enable soft forking where a consensus from a possible node is identified as faulty and tolerated in the SDTE. The decision process may be operable for hard forking. The hard forking may blacklist the node. The hard forking may fork the node out of the DLN.

The FDTFM may evaluate a dynamic decision deviation in the DLN. The FDTFM may integrate the SDTE. The FDTFM may evaluate and reconcile the behavior of a blacklisted node. The FDTFM may enable an efficient and effective reconciliation process.

The FDTFM may implement a temporary blockchain forking enabling a secure and efficient reconciliation mechanism. The FDTFM may implement a soft forking enabling a secure and efficient reconciliation mechanism.

Soft forking in relation to nodal spoofing may refer to a backward-compatible update to a network’s protocol that may be used to enhance spoofing detection and prevention. Soft forking may allow for implementation of minor changes or optimizations to the spoofing detection algorithms without disrupting the entire network.

Soft forking may introduce new rules for node validation that may be compatible with existing nodes, allowing both upgraded and non-upgraded nodes to continue operating on the network. For example, a soft fork may introduce more stringent checks on RSS values to detect potential spoofing attempts, while still allowing older nodes to function normally. Soft forking may gradually improve spoofing detection without forcing immediate network-wide changes but may leave vulnerabilities in non-upgraded nodes.

Hard forking in the context of nodal spoofing may involve a significant, non-backward-compatible change to the network’s protocol to combat sophisticated spoofing attacks. Hard forking may create a new version of a blockchain that is incompatible with the previous one, requiring all nodes to be upgraded to maintain consensus.

Hard forking may allow for the implementation of major changes in how nodes are authenticated and verified, potentially introducing entirely new anti-spoofing mechanisms. An example of a hard fork could be the implementation of a new cryptographic algorithm for node authentication that may render previous node spoofing techniques obsolete. One or more nodes may dynamically update their software as necessary.

Hard forking may also completely remove a node from the DLN. Hard forks may implement more robust anti-spoofing measures across the DLN. Both soft and hard forks may be used to address node spoofing, with a choice between soft and hard forks depending on the severity of the node spoofing threat and the extent changes are required to mitigate the threat.

The FDTFM may combine methods for identifying node spoofing using a fuzzy algorithm method and a decision twin method. The FDTFM may mitigate node spoofing in the DLM by combining the fuzzy algorithm method and the decision twin method.

Methods may include identifying node spoofing in a DLN. The methods may include identifying, via a FDTFM, node spoofing in the DLN. The methods may include capturing, via a FAH process, a consensus from nodes.

The methods may include creating, via the FAH process, an SDTE based on a simulated consensus derived from inputs from an intelligent nodal validator, fuzzy output, and nodal models from a nodal DB to derive a decision deviation. The methods may include controlling and configuring, via a nodal DNA generator, information from the nodes to generate nodal DNA. The nodal DNA may include, e.g., a unique identifier, nodal configurations, node roles, behavioral patterns, and storage capacity. The storage capacity may be for storing blockchain information.

The methods may include creating, via the decision deviation, a decisioning of forking of the nodes from the DLN. The methods may include creating, via a decision process for lower deviation, higher deviation, and nodal forking.

The methods may include learning, via an intelligent nodal validator, behavior from the forking of the nodes. The methods may include updating, via the intelligent nodal validator, an ideal nodal genome for improved decision making.

The methods may include evaluating, via the FAH, a consensus provided by the nodes and derive valid weights based on set criteria and attributes unique to the DLN. The methods may include executing, via the FAH, smart contracts on the nodes. The methods may include enabling, via the smart contracts, a decentralized and autonomous evaluation of nodal behavior

The methods may include generating, the DNA generator, nodal DNA from extracted node configurations and transactional behavior. The methods may include adding, via the DNA generator, an update to the nodal behavior by incremental genome updates to analyze and publish the nodal behavior.

The methods may include passing, via the nodal DNA generator, feedback information across the nodes. The methods may include publishing, via the nodal DNA generator, DNA information as feedback.

Methods may include capturing, via the nodal DNA generator, transactional information to determine behavior of the nodes. Methods may include enabling, via the decision process, soft forking. Methods may include identifying a consensus from a possible node as faulty and tolerated in the SDTE.

Methods may include hard forking, via the decision process, a node. Methods may include blacklisting, via the hard forking, the node. Methods may include forking, via the decision process, the node out of the DLN.

Methods may include evaluating, via the FDTFM, a dynamic decision deviation in the DLN. Methods may include integrating, via the FDTFM, the SDTE. Methods may include evaluating and reconciling, via the FDTFM, the behavior of a blacklisted node. Methods may include enabling, via the FDTFM, an efficient and effective reconciliation process.

Methods may include implementing, via the FDTFM, a temporary blockchain forking. Methods may include enabling, via the FDTFM, a secure and efficient reconciliation mechanism.

Methods may include implementing, via the FDTFM, a soft forking. Methods may include enabling, via the FDTFM, a secure and efficient reconciliation mechanism.

Methods may include combining, via the FDTFM, methods for identifying node spoofing using a fuzzy algorithm and decision twin solution. Methods may include detecting, via the FDTFM, node spoofing in the DLN. Methods may include mitigating, via the FDTFM, node spoofing in the DLN.

Systems and methods described herein are illustrative. Systems and methods in accordance with this disclosure will now be described in connection with the figures, which form a part hereof. The figures show illustrative features of system and method steps in accordance with the principles of this disclosure. It is understood that other embodiments may be utilized, and that structural, functional, and procedural modifications may be made without departing from the scope and spirit of the present disclosure.

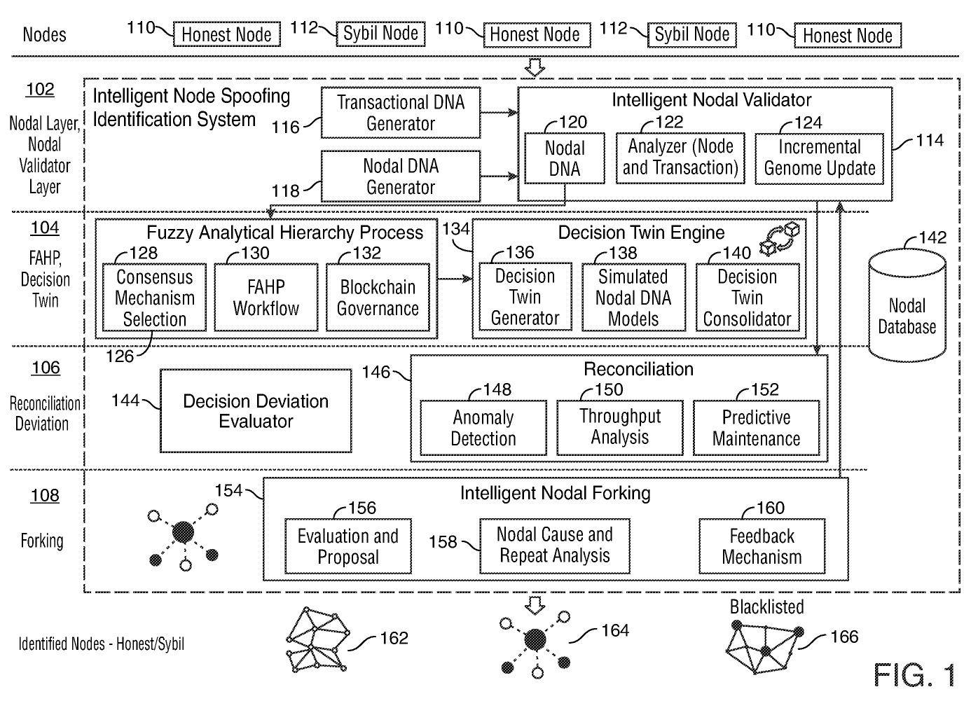

FIG. 1 shows an illustrative flow chart 100 for a system and method in accordance with principles of the disclosure.

Illustrative process flow 100 may include nodes. The nodes may include, e.g., an honest node 110, a sybil node 112, etc. Illustrative process flow 100 may include a nodal layer, nodal validator layer 102. The nodal layer, nodal validator layer 102 may include, e.g., an intelligent node spoofing identification system.

The intelligent node spoofing identification system may include a transactional DNA generator 116, a nodal DNA generator 118, and an intelligent nodal validator 114. The intelligent nodal validator 114 may include nodal DNA 120, an analyzer (node and transaction) 122, and an incremental genome update 124.

The nodes (e.g., honest node 110 and sybil node 112) may send nodal information and feedback to the intelligent node spoofing identification system. The transactional DNA generator 116 and the nodal DNA generator 118 may send nodal information and feedback to the intelligent nodal validator 114.

Illustrative process flow 100 may include a Fuzzy Analytical Hierarchical Process (“FAHP”), decision twin 104. The FAHP, decision twin 104 may include a fuzzy analytical hierarchy process 126 and a decision twin engine 134.

The fuzzy analytical hierarchy process 126 may include a consensus mechanism selection 128, a FAHP workflow 130, and a blockchain governance 132. The decision twin engine 134 may include a decision twin generator 136, simulated nodal DNA models 138, and a decision twin consolidator 140. The nodal DNA 120 may send nodal information to the fuzzy analytical hierarchy process 126.

The intelligent node spoofing identification system may include a nodal database 142. The nodal database 142 may provide nodal information to the intelligent node spoofing identification system.

The intelligent node spoofing identification system may include reconciliation deviation 106. Reconciliation deviation 106 may include a decision deviation evaluator 144 and a reconciliation 146. The reconciliation 146 may include an anomaly detection 148, a throughput analysis 150, and a predictive maintenance 152.

The intelligent node spoofing identification system may include forking 108. Forking 108 may include an intelligent nodal forking 154. The intelligent nodal forking 154 may include an evaluation and proposal 156, a nodal cause and repeat analysis 158, and a feedback mechanism 160.

The intelligent node spoofing identification system may output and/or publish identified nodes (e.g., honest/sybil). The identified nodes may include connected nodes 162, disconnected nodes 164, and blacklisted nodes 166.

The fuzzy analytical hierarchy process may send nodal information and feedback to the decision twin engine 134. The intelligent nodal validator 114 may send nodal information and feedback to the reconciliation 146. The intelligent nodal forking may send nodal information and feedback to the intelligent nodal validator 114.

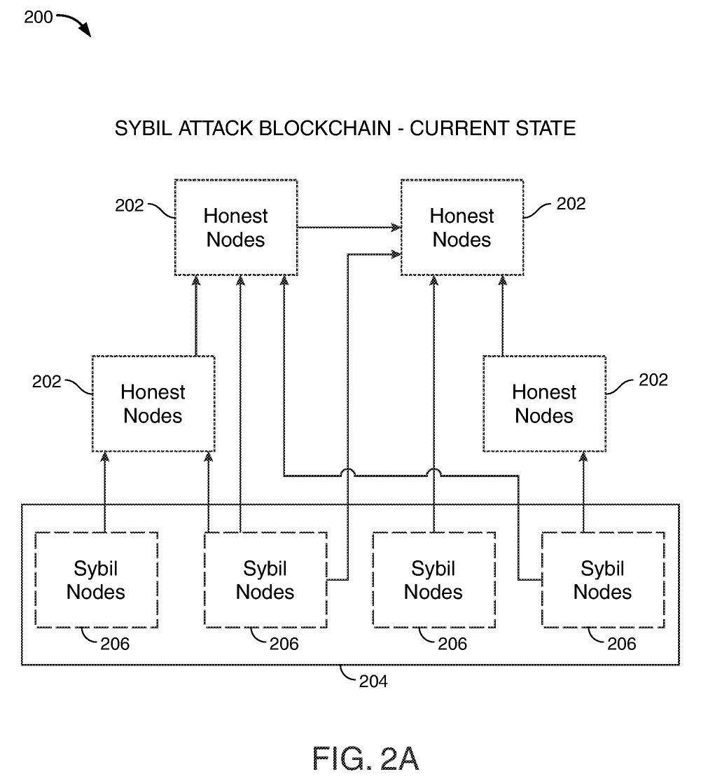

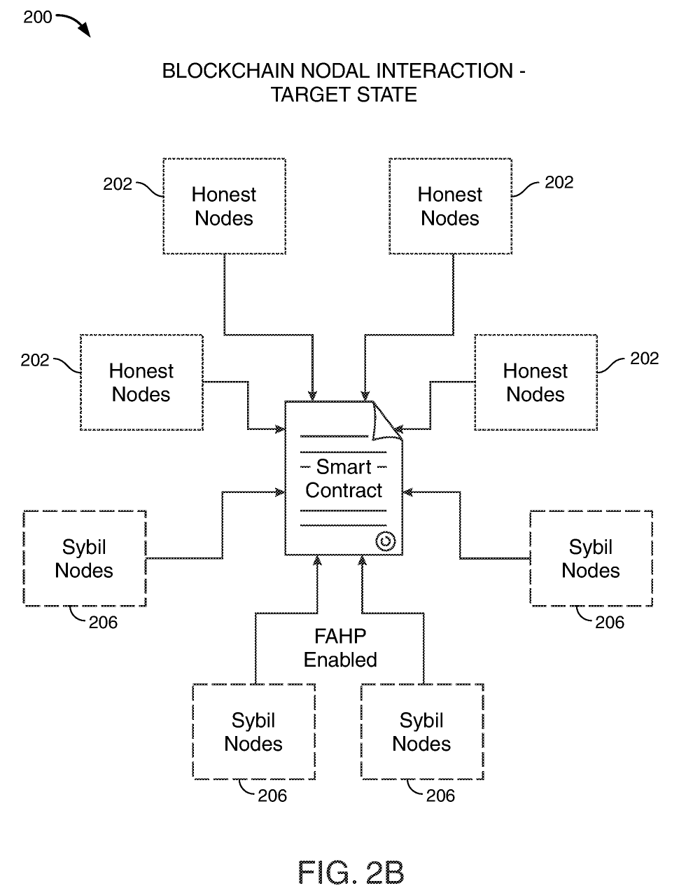

FIG. 2A shows an illustrative diagram 200 for a system and method in accordance with principles of the disclosure.

The illustrative diagram 200 may include a sybil attack blockchain in its current state. The illustrative diagram 200 may include honest nodes 202 and sybil nodes 206. The sybil nodes 206 may be held in a sybil node environment 204.

The sybil nodes 206 may send nodal information and feedback to the honest nodes 202. The honest nodes 202 may send nodal information and feedback to other honest nodes 202.

FIG. 2B shows an illustrative diagram 200 for a system and method in accordance with principles of the disclosure.

The illustrative diagram 200 may include a blockchain nodal interaction in its target state. The illustrative diagram 200 may include honest nodes 202 and sybil nodes 206. The illustrative diagram 200 may include a smart contract.

The sybil nodes 206 may send nodal information and feedback to the smart contract. The honest nodes 202 may send nodal information and feedback to the smart contract. The smart contract may be FAHP enabled.

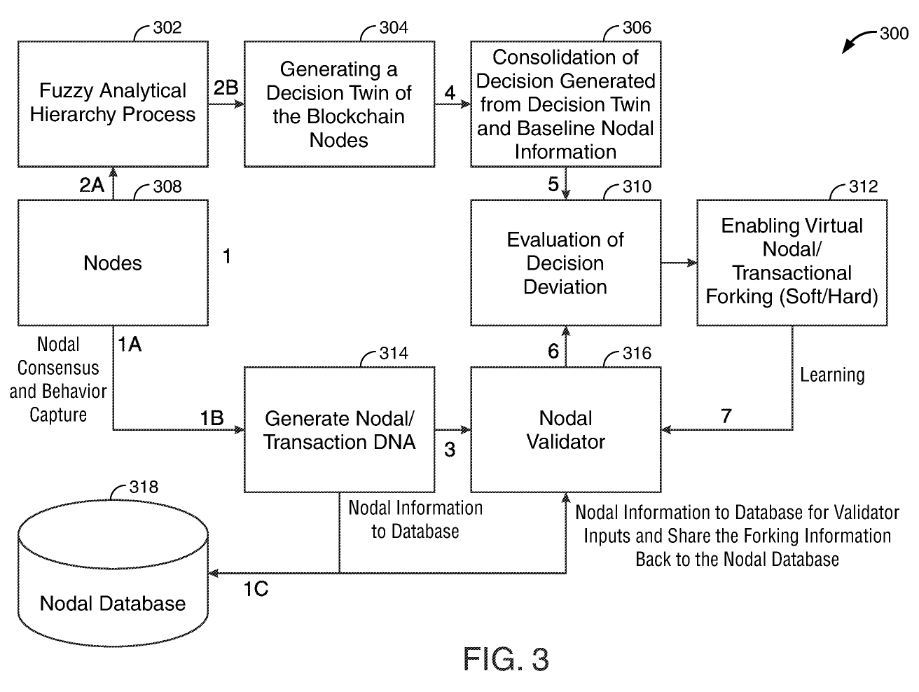

FIG. 3 shows an illustrative flow chart 300 for a system and method in accordance with principles of the disclosure.

The illustrative flow chart 300 may include nodes 308. The nodes 308 may be connected to a nodal database 318. (1) The nodes 308 may retain, process, and analyze their nodal information. (1A) The nodes 308 may send nodal information and feedback to generate nodal/transaction DNA 314. (1B) Nodal consensus and behavior capture may occur at generate nodal/transaction DNA. (1C) Generate nodal/transaction DNA 314 may send nodal information and feedback to the nodal database 318. The nodal database 318 may send nodal information and feedback to the nodal validator 316 for validator inputs. The nodal validator 316 may share forking information with the nodal database 318.

(2A) The nodes 308 may send nodal information and feedback to a fuzzy analytical hierarchy process 302. (2B) The fuzzy analytical hierarchy process 302 may send nodal information and feedback to generating a decision twin of the blockchain nodes 304. (3) The generate nodal/transaction DNA 314 may send nodal information and feedback to a nodal validator 316. (4) The generating a decision twin of the blockchain nodes 304 may send nodal information and feedback to consolidation of decision generated from decision twin and baseline nodal information 306.

(5) The consolidation of decision generated from decision twin and baseline nodal information 306 may send nodal information and feedback to an evaluation decision deviation 310. (6) The nodal validator 316 may send nodal information and feedback to the evaluation decision deviation 310. The evaluation decision deviation 310 may send nodal information and feedback to enabling virtual nodal/transactional forking (soft/hard) 312. (7) The enabling virtual nodal/transactional forking (soft/hard) 312 may send learning from the nodal information and feedback to the nodal validator 316.

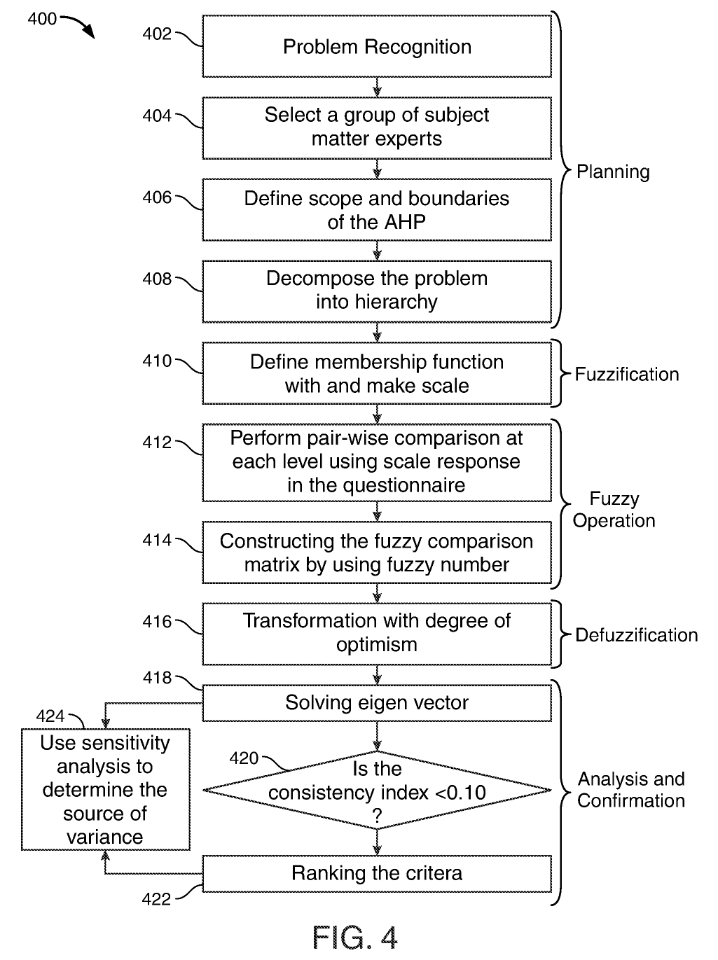

FIG. 4 shows an illustrative flow chart 400 for a system and method in accordance with principles of the disclosure.

FIG. 4 illustrative flow chart 400 may include problem recognition 402. The nodal information and feedback may be received at problem recognition 402. Problem recognition 402 may be a module that is operable to recognize problems and spoofing with a plurality of nodes.

Problem recognition 402 may send nodal information and feedback to select a group of subject matter experts 404. After the selecting of a group of subject matter experts 404, nodal information and feedback may be sent to define the scope and boundaries of the analytical hierarchy process (“AHP”) 406.

After defining the scope and boundaries of the analytical hierarchy process (“AHP”) 406, the nodal information and feedback may be sent to decomposes the problem into hierarchy 408. The problem recognition 402, selecting a group of subject matter experts 404, defining a scope and boundaries of the AHP 406, and the decomposing the problem into hierarchy 408 may be considered planning.

After decomposing the problem in hierarchy 408, the nodal information and feedback may be sent to define membership function with and make scale 410. The defining membership function and making scale 410 may be considered fuzzification.

After defining a membership function and making scale 410, the nodal information and feedback may be sent to perform a pair-wise comparison at each level using scale response in the questionnaire 412. After performing a pair-wise comparison at each level using scale response in the questionnaire 412, the nodal information and feedback may be sent to constructing the fuzzy comparison matrix by using a fuzzy number 414. The performing pair-wise comparison at each level using scale response in the questionnaire 412 and the fuzzy comparison matrix by using a fuzzy number 414 may be considered a fuzzy operation.

After constructing the fuzzy comparison matrix by using a fuzzy number 414, the nodal information and feedback may be sent to transformation with degree of optimism 416. The transformation with degree of optimism 416 may be considered defuzzification.

After the transformation with degree of optimism 416, the nodal information and feedback may be sent to solving eigenvector 418. After solving eigenvector 418, the nodal information and feedback may be sent to analyze: is the consistence index <0.10, 420. After solving eigenvector 418, the nodal information and feedback may be sent use sensitivity analysis to determine the source of variance 424.

After analyzing: is the consistence index <0.10, 420, the nodal information and feedback may be send to ranking the criteria 422. After ranking the criteria 422, the nodal information and feedback may be sent to use sensitivity analysis to determine the source of variance 424. Solving eigenvector 418, analyzing: is the consistence index <0.10, 420, ranking the criteria 422, and using sensitivity analysis to determine the source of variance 424 may be considered analysis and confirmation.

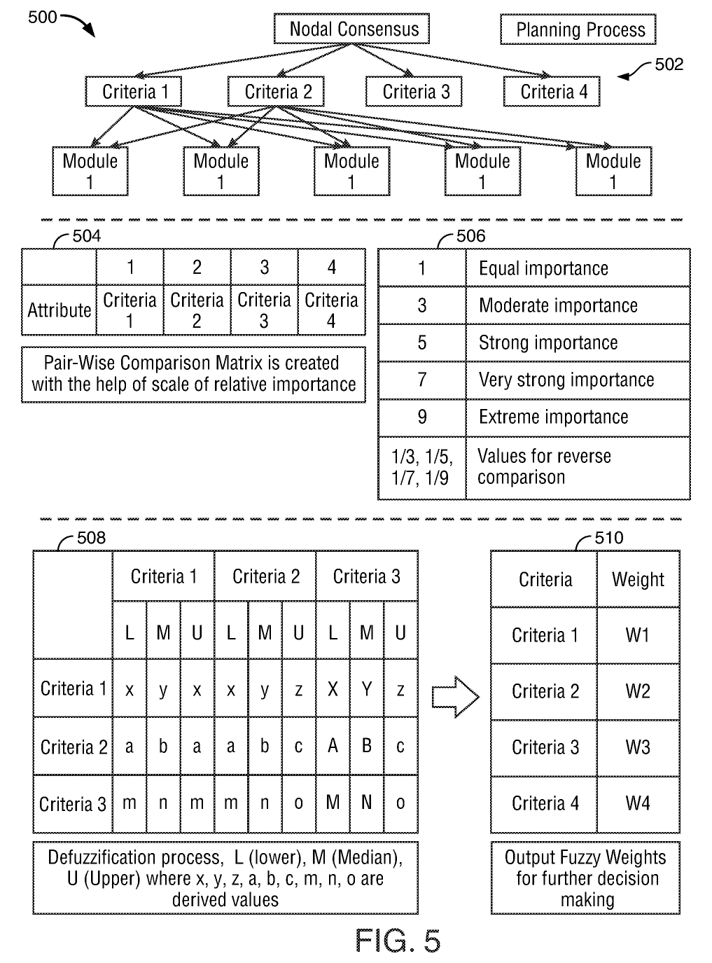

FIG. 5 shows an illustrative diagram 500 for a system and method in accordance with principles of the disclosure.

FIG. 5 illustrative diagram 500 shows nodal consensus. Illustrative diagram 500 also shows planning. Illustrative diagram 500 shows criteria 1, criteria 2, criteria 3, and criteria 4, 502 emanating from nodal consensus. Illustrative diagram 500 also shows modules, e.g., module 1, module 1, module 1, module 1, and module 1. Module 1 may emanate from, e.g., criteria 1, criteria 2, criteria 3, and criteria 4.

Illustrative diagram 500 shows chart 504. Chart 504 illustrates attribute 1 as criteria 1, attribute 2 as criteria 2, attribute 3 as criteria 3, attribute 4 as criteria 4. Chart 504 shows that a Pair-Wise Comparison Matrix is created with the help of scale of relative importance.

Illustrative diagram 500 includes chart 506. Chart 506 shows number 1 corresponding to equal importance. Chart 506 shows number 3 corresponding to moderate importance. Chart 506 shows number 5 corresponding to strong importance. Chart 506 shows number 9 corresponding to extreme importance. Chart 506 shows number 1/3, 1/5, 1/7, and 1/9 corresponding to values for reverse comparison.

Illustrative diagram 500 includes chart 508. Chart 508 includes criteria 1, criteria 2, and criteria 3. Criteria 1, 2, and 3 may represent L, M, and U. Criteria 1 may represent x, y, x, or x, y, and z, or X, Y, z, etc. Criteria 2 may represent a, b, and a, or a, b, c, or A, B, c, etc. Criteria 3 may represent m, n, m, or m, n, o, or M, N, o, etc. Chart 508 includes a defuzzification process, L (lower), M (median), U (upper) and where x, y, z, a, b, c, m, n, o are derived values.

Illustrative diagram 500 includes chart 510. Chart 510 may include criteria and weights. Criteria may include criteria 1, 2, 3, and 4. Weights may include W1, W2, W3, and W4. In chart 510, criteria 1, 2, 3, and 4 correspond to W1, W2, W3, and W4, respectively. Chart 510 illustrates that criteria and weights may output fuzzy weights for further decision making.

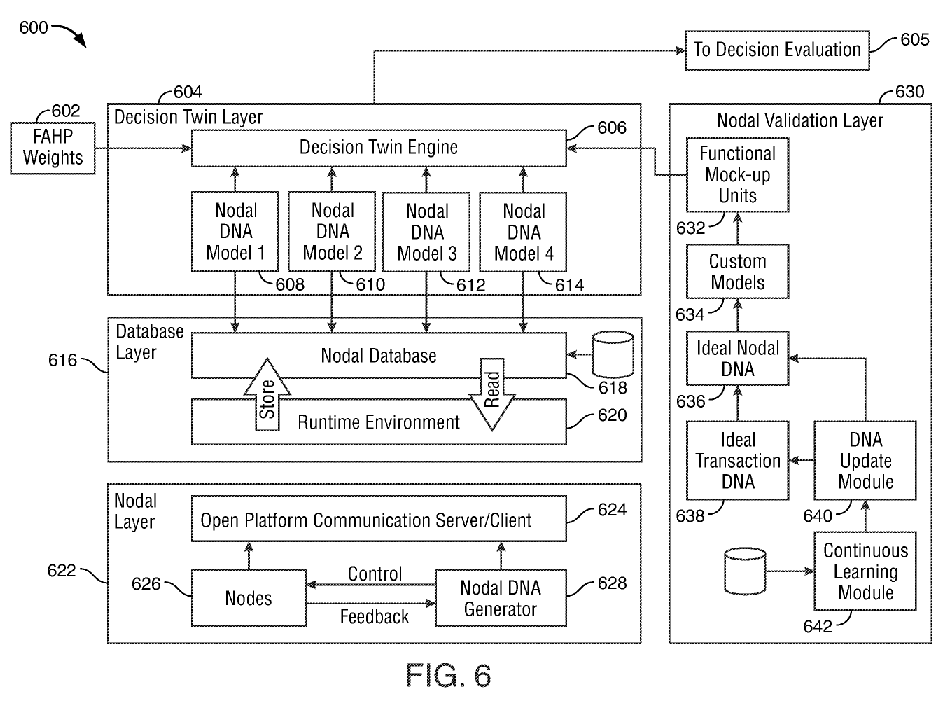

FIG. 6 shows an illustrative diagram 600 for a system and method in accordance with principles of the disclosure.

Illustrative diagram 600 shows FAHP Weights 602. FAHP Weights 602 may send nodal information to Decision Twin Engine 606 within Decision Twin Layer 604. Decision Twin Layer 604 may contain Nodal DNA Model 1, 608, Nodal DNA Model 2, 610, Nodal DNA Model 3, 612, and Nodal DNA Model 4, 614. Decision Twin Engine 606 may receive nodal information from Nodal DNA Model 1, 608, Nodal DNA Model 2, 610, Nodal DNA Model 3, 612, and Nodal DNA Model 4, 614.

Nodal DNA Model 1, 608, Nodal DNA Model 2, 610, Nodal DNA Model 3, 612, and Nodal DNA Model 4, 614 may send nodal information to Nodal Database 618 within database layer 616. Database layer 616 may include runtime environment 620. Runtime environment 620 may send store information to nodal database 618. Nodal database 618 may send read information to runtime environment 620. Decision Twin Layer 602 may send nodal information to decision evaluation 605.

Illustrative diagram 600 includes nodal validation layer 630. Nodal validation layer 630 includes functional mock-up units 632. Functional mock-up units 632 may send nodal information to decision twin engine 606 within decision twin layer 604. Nodal validation layer 630 includes continuous learning module 642.

Continuous learning module 642 may send nodal information to DNA update module 640. DNA update module 640 may send nodal information to ideal transaction DNA 638. Ideal transaction DNA 638 may send nodal information to ideal nodal DNA 636. Ideal nodal DNA 636 may send nodal information to custom models 634. Custom models 634 may send nodal information to functional mock-up units 632.

Illustrative diagram 600 includes nodal layer 622. Nodal layer 622 includes open platform communication server/client 624, nodes 626, and nodal DNA generator 628. Nodes 626 may send nodal information to open platform communication server/client 624. Nodal DNA generator 628 may send nodal information to open platform communication server/client 624. Nodes 626 may send feedback information to nodal DNA generator 628. Nodal DNA generator 628 may send control information to nodes 626.

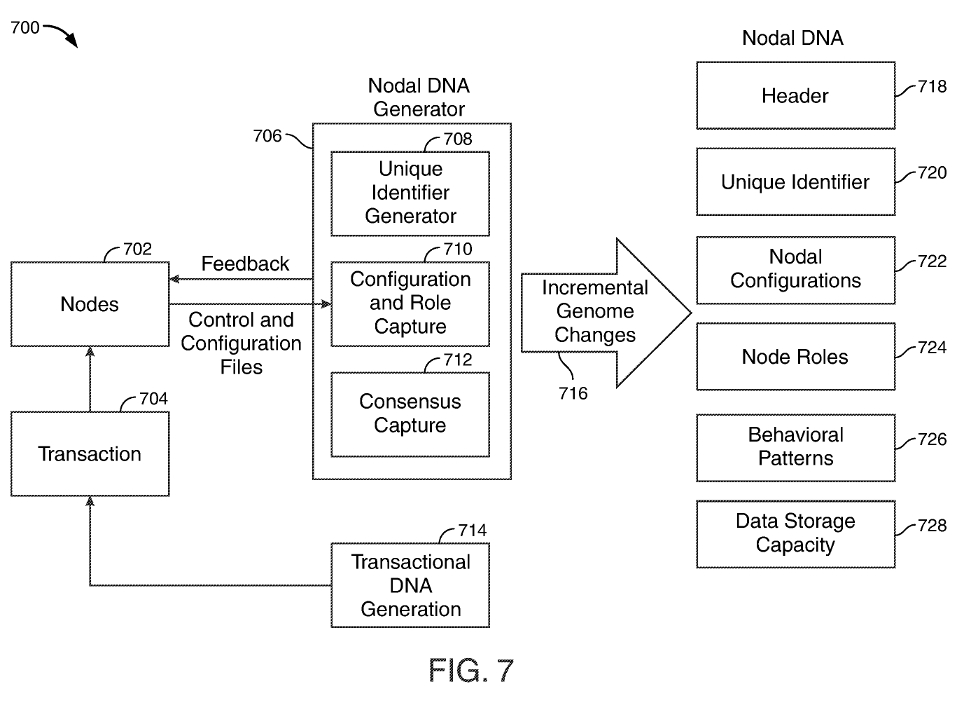

FIG. 7 shows an illustrative diagram 700 for a system and method in accordance with principles of the disclosure.

Illustrative diagram 700 includes transactional DNA generation 714. Transactional DNA generation 714 may send nodal information to transaction 704. Transaction 704 may send nodal information to nodes 702.

Nodes 702 may send control and configuration files to configuration and role capture 710 within nodal DNA generator 706. Nodal DNA generator 706 may include unique identifier generator 708. Nodal DNA generator 706 may include consensus capture 712. Configuration and role capture 710 may send feedback information to nodes 702.

Nodal DNA generator 706 may send nodal information, e.g., in the form of incremental genome changes 716 to nodal DNA. Nodal DNA may include a header 718, a unique identifier 720, nodal configurations 722, node roles 724, behavioral patterns 726, and data storage capacity 728.

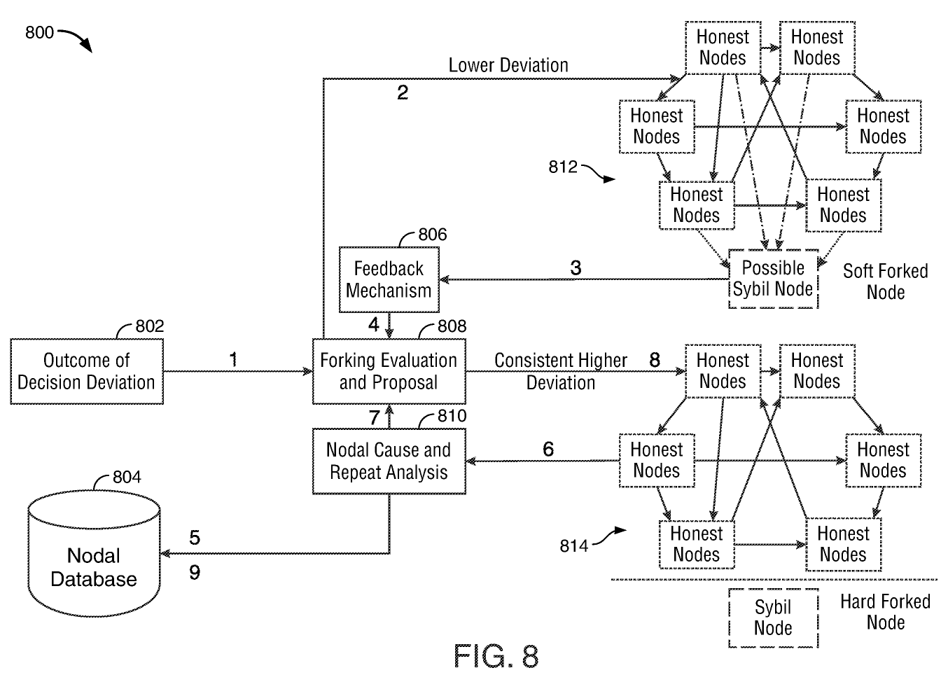

FIG. 8 shows an illustrative diagram 800 for a system and method in accordance with principles of the disclosure.

Illustrative diagram 800 shows outcome of decision deviation 802. Outcome of decision deviation 802 may (1) send nodal information to forking evaluation and proposal 808. Forking evaluation and proposal 808 may (2) send nodal information via, e.g., lower deviation to honest nodes 812. Honest nodes 812 may send nodal information to other honest nodes 812. Honest nodes 812 may send nodal information to a possible sybil node via, e.g., a soft forked node.

The possible sybil node may (3) send nodal information to feedback mechanism 806. Feedback mechanism 806 may (4) send nodal information and feedback to forking evaluation and proposal 808.

The forking evaluation and proposal 808 may (8) send nodal information via, e.g., a consistent higher deviation to honest nodes 814. Honest nodes 814 may send nodal information to other honest nodes 814. A sybil node may be a hard forked node existing outside the nodal network. The honest nodes may (6) send nodal information to nodal cause and repeat analysis 810. Nodal cause and repeat analysis may (7) send nodal information to forking evaluation and proposal 808. Nodal cause and repeat analysis 810 may (5) and (9) send nodal information to nodal database 804.

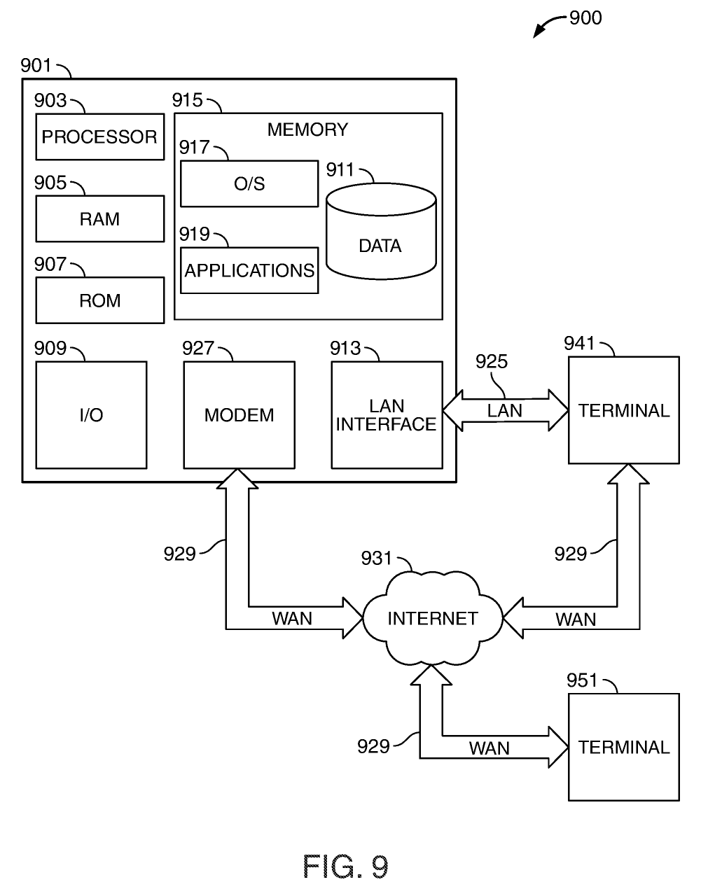

FIG. 9 shows an illustrative block diagram of system 900 that includes computer 901. Computer 901 may alternatively be referred to herein as an “engine,” “server,” or a “computing device.” Computer 901 may be a workstation, desktop, laptop, tablet, smartphone, or any other suitable computing device. Elements of system 900, including computer 901, may be used to implement various aspects of the systems and methods disclosed herein. Each of the systems, methods and algorithms illustrated below may include some or all of the elements and apparatus of system 900.

Computer 901 may include processor 903 for controlling the operation of the device and its associated components, and may include RAM 905, ROM 907, input/output (“I/O”) 909, and a non-transitory or non-volatile memory 915. Machine-readable memory may be configured to store information in machine-readable data structures. Processor 903 may also execute all software running on the computer. Other components commonly used for computers, such as EEPROM or flash memory or any other suitable components, may also be part of computer 901.

Memory 915 may include any suitable permanent storage technology, such as a hard drive. Memory 915 may store software including the operating system 917 and application program(s) 919 along with any data 911 needed for the operation of the system 900. Memory 915 may also store videos, text, and/or audio assistance files. The data stored in memory 915 may also be stored in cache memory, or any other suitable memory.

I/O module 909 may include connectivity to a microphone, keyboard, touch screen, mouse, and/or stylus through which input may be provided into computer 901. The input may include input relating to cursor movement. The input/output module may also include one or more speakers for providing audio output and a video display device for providing textual, audio, audiovisual, and/or graphical output. The input and output may be related to computer application functionality.

System 900 may be connected to other systems via a local area network (“LAN”) interface 913. System 900 may operate in a networked environment supporting connections to one or more remote computers, such as terminals 941 and 951. Terminals 941 and 951 may be personal computers or servers that include many or all of the elements described above relative to system 900. The network connections depicted in FIG. 9 include a LAN 925 and a wide area network (“WAN”) 929 but may also include other networks. When used in a LAN networking environment, computer 901 may connect to LAN 925 through LAN interface 913 or an adapter. When used in a WAN networking environment, computer 901 may include modem 927 or other means for establishing communications over WAN 929, such as Internet 931.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 919, which may be used by computer 901, may include computer executable instructions for invoking functionality related to communication, such as e-mail, Short Message Service (“SMS”), and voice input and speech recognition applications. Application program(s) 919 (which may be alternatively referred to herein as “plugins,” “applications,” or “apps”) may include computer executable instructions for invoking functionality related to performing various tasks. Application program(s) 919 may utilize one or more algorithms that process received executable instructions, perform power management routines or other suitable tasks.

The invention may be described in the context of computer-executable instructions, such as application(s) 919, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 901 and/or terminals 941 and 951 may also include various other components, such as a battery, speaker, and/or antennas (not shown). Components of computer system 901 may be linked by a system bus, wirelessly or by other suitable interconnections. Components of computer system 901 may be present on one or more circuit boards. In some embodiments, the components may be integrated into a single chip. The chip may be silicon-based.

Terminal 941 and/or terminal 951 may be portable devices such as a laptop, cell phone, tablet, smartphone, or any other computing system for receiving, storing, transmitting and/or displaying relevant information. Terminal 941 and/or terminal 951 may be one or more user devices. Terminals 941 and 951 may be identical to system 900 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

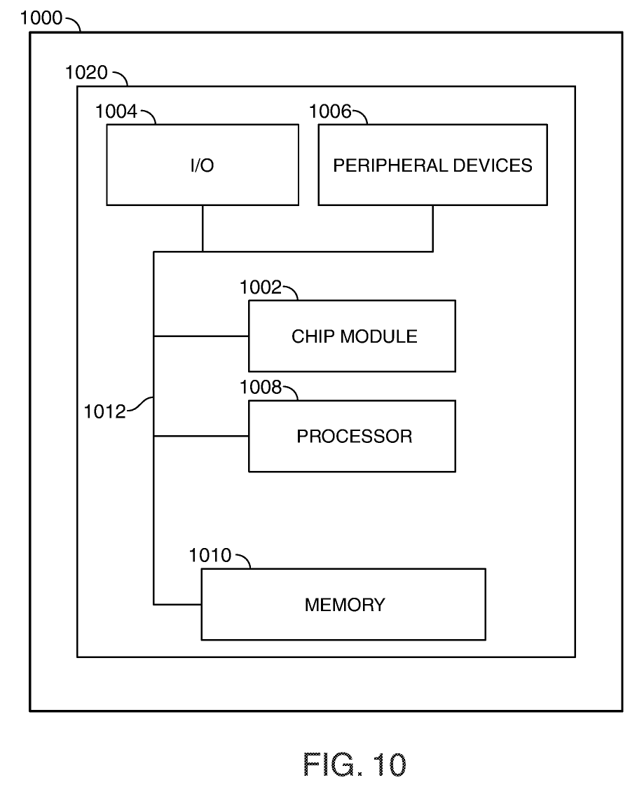

FIG. 10 shows illustrative apparatus 1000 that may be configured in accordance with the principles of the disclosure. Apparatus 1000 may be a computing device. Apparatus 1000 may include one or more features of the apparatus shown in FIG. 9. Apparatus 1000 may include chip module 1002, which may include one or more integrated circuits, and which may include logic configured to perform any suitable logical operations.

Apparatus 1000 may include one or more of the following components: I/O circuitry 1004, which may include a transmitter device and a receiver device and may interface with fiber optic cable, coaxial cable, telephone lines, wireless devices, PHY layer hardware, a keypad/display control device or any other suitable media or devices; peripheral devices 1006, which may include counter timers, real-time timers, power-on reset generators or any other suitable peripheral devices; logical processing device 1008, which may compute data structural information and structural parameters of the data; and machine-readable memory 1010.

Machine-readable memory 1010 may be configured to store in machine-readable data structures: machine executable instructions, (which may be alternatively referred to herein as “computer instructions” or “computer code”), applications such as applications 1019, signals, and/or any other suitable information or data structures.

Components 1002, 1004, 1006, 1008, and 1010 may be coupled together by a system bus or other interconnections 1012 and may be present on one or more circuit boards such as circuit board 1020. In some embodiments, the components may be integrated into a single chip. The chip may be silicon-based.

The disclosure may be operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc., that perform tasks or implement abstract data types. The disclosure may also be practiced in distributed computing environments where tasks are performed by remote processing devices that are linked through a communications network. In a distributed computing environment, program modules may be in both local and remote computer storage media including memory storage devices.

The steps of methods and systems may be performed in orders beyond the order shown and/or described herein. Embodiments may omit steps shown and/or described in connection with illustrative methods. Embodiments may include steps that are neither shown nor described in connection with illustrative methods.

Illustrative methods and systems steps may be combined. For example, an illustrative method may include steps shown in connection with another illustrative method.

Methods and systems may omit features shown and/or described in connection with illustrative methods and systems. Embodiments may include features that are neither shown nor described in connection with the illustrative methods and systems. Features of illustrative methods and systems may be combined. For example, an illustrative embodiment may include features shown in connection with another illustrative embodiment.

The drawings show illustrative features of methods and systems in accordance with the principles of the disclosure. The features are illustrated in the context of selected embodiments. It will be understood that features shown in connection with one of the embodiments may be practiced in accordance with the principles of the disclosure along with features shown in connection with another of the embodiments.

One of ordinary skill in the art will appreciate that the steps shown and described herein may be performed in other ways and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for using an FDTFM for identifying node spoofing in a DLN are provided. Persons skilled in the art will appreciate that the present disclosure can be practiced in other ways. The described embodiments are presented for purposes of illustration—not limitation—and the present disclosure is limited only by the claims that follow.

What is claimed is:

1. A system for identifying node spoofing in a distributed ledger network (“DLN”), the system comprising:
a fuzzy decision twin and forking mechanism (“FDTFM”), the FDTFM operable to identify node spoofing in nodes in the DLN;
a fuzzy analytical hierarchical (“FAH”) process, the FAH process operable to capture a consensus from the nodes and generate a simulated decision twin environment (“SDTE”), the SDTE being based on a simulated consensus derived from inputs from an intelligent nodal validator, a fuzzy output, and nodal models from a nodal database (“DB”), the SDTE operable to derive a decision deviation, the decision deviation operable to generate a decisioning of forking of the nodes;
a nodal deoxyribonucleic acid (“DNA”) generator, the nodal DNA generator operable to control and configure information from the nodes to generate nodal DNA, the nodal DNA comprising a unique identifier, nodal configurations, node roles, behavioral patterns, and storage capacity for storing blockchain information;
a decision process for adjusting the decisioning of forking of the nodes for lower deviation and higher deviation, the decision process operable to generate nodal forking, the nodal forking increasing or decreasing a nodal deviation; and
an intelligent nodal validator, the intelligent nodal validator operable to learn nodal behavior from the nodal forking and further operable to update an ideal nodal genome for improved decision making;
wherein:
the FAH process is further operable to:
evaluate a consensus provided by the nodes;
derive valid weights based on set criteria and attributes unique to the DLN; and
execute smart contracts on the nodes, the smart contracts enabling a decentralized and autonomous evaluation of the nodal behavior; and
the nodal DNA generator is further operable to:
generate the nodal DNA from extracted node configurations and transactional behavior; and
incrementally update the nodal behavior by genome updates.

2. The system of claim 1, wherein the nodal DNA generator is operable to pass feedback information across the nodes to publish the nodal behavior as feedback.

3. The system of claim 1, wherein the nodal DNA generator is operable to capture transactional information to determine the nodal behavior.

4. The system of claim 1, wherein the decision process is operable for soft forking a node in the DLN, where a consensus from the node is identified as faulty and tolerated in the SDTE.

5. The system of claim 1, wherein the decision process is operable for hard forking a node in the DLN, the hard forking blacklisting the node and removing the node from the DLN.

6. The system of claim 1, wherein the FDTFM is further operable to evaluate a dynamic decision deviation for a lower deviation or a higher deviation in the DLN.

7. The system of claim 1, wherein the FDTFM is further operable to integrate the SDTE to evaluate and reconcile behavior of a blacklisted node enabling a reconciliation process for the DLN.

8. The system of claim 1, wherein the FDTFM is further operable to implement a temporary blockchain forking enabling a secure reconciliation mechanism.

9. The system of claim 1, wherein the FDTFM is further operable to implement a soft forking enabling a secure reconciliation mechanism.

10. The system of claim 1, wherein the FDTFM is further operable to:
combine methods for identifying node spoofing using a fuzzy algorithm method and decision twin method; and
mitigate node spoofing in the DLM based on the combined methods.

11. A method for identifying node spoofing in a distributed ledger network (“DLN”), the method comprising:
identifying, via a fuzzy decision twin and forking mechanism (“FDTFM”), node spoofing in nodes in the DLN;
capturing, via a fuzzy analytical hierarchical (“FAH”) process, a consensus from the nodes;
generating, via the FAH process, a simulated decision twin environment (“SDTE”), the SDTE being based on a simulated consensus derived from inputs from an intelligent nodal validator, a fuzzy output, and nodal models from a nodal database (“DB”),
deriving, via the SDTE, a decision deviation;
generating, via the decision deviation, a decisioning of forking of the nodes;
controlling and configuring, via a nodal deoxyribonucleic acid (“DNA”) generator, information from the nodes to generate nodal DNA, the nodal DNA comprising a unique identifier, nodal configurations, node roles, behavioral patterns, and storage capacity for storing blockchain information;
generating, via a decision process for adjusting the decisioning of forking of the nodes for lower deviation and higher deviation, nodal forking for increasing or decreasing a nodal deviation; and
learning, via an intelligent nodal validator, nodal behavior from the nodal forking;
updating, via the intelligent nodal validator, an ideal nodal genome for improved decision making;
evaluating, via the FAH, a consensus provided by the nodes;
deriving valid weights based on set criteria and attributes unique to the DLN;
executing, via the FAH, smart contracts on the nodes;
enabling, via the smart contracts, a decentralized and autonomous evaluation of the nodal behavior;
generating, via the DNA generator, the nodal DNA from extracted node configurations and transactional behavior; and
updating, via the DNA generator, the nodal behavior incrementally by genome updates.

12. The method of claim 11, the method further comprising:
passing, via the nodal DNA generator, feedback information across the nodes; and
publishing, via the nodal DNA generator, the nodal behavior as feedback.

13. The method of claim 11, the method further comprising capturing, via the nodal DNA generator, transactional information to determine behavior of the nodes.

14. The method of claim 11, the method further comprising:
identifying, via the decision process, a consensus from a node as faulty and tolerated in the SDTE; and
enabling, via the decision process, soft forking of the node.

15. The method of claim 11, the method further comprising:
hard forking, via the decision process, a node;
blacklisting, via the hard forking, the node; and
forking, via the decision process, the node out of the DLN.

16. The method of claim 11, the method further comprising evaluating, via the FDTFM, a dynamic decision deviation for a lower deviation or a higher deviation in the DLN.

17. The method of claim 11, the method further comprising:
integrating, via the FDTFM, the SDTE;
evaluating, via the FDTFM, behavior of a blacklisted node;
reconciling, via the FDTFM, the behavior of the blacklisted node; and
enabling, via the FDTFM, a reconciliation process for the DLN.

18. The method of claim 11, the method further comprising:
implementing, via the FDTFM, a temporary blockchain forking; and
enabling, via the FDTFM, a secure reconciliation mechanism.

19. The method of claim 11, the method further comprising:
implementing, via the FDTFM, a soft forking; and
enabling, via the FDTFM, a secure reconciliation mechanism.

20. The method of claim 11, the method further comprising:
combining, via the FDTFM, methods for identifying node spoofing using a fuzzy algorithm method and decision twin method; and
detecting, via the FDTFM, node spoofing in the DLN; and
mitigating, via the FDTFM, the node spoofing in the DLN based on the combined methods.
